(19) United States
(12) Patent Application Publication
(10) Pub. No.: US 2026/0031932 A1
(43) Pub. Date: Jan. 29, 2026

(54) WIRELESS LOCAL AREA NETWORK (WLAN) UNEQUAL DATA PROTECTION

(71) Applicant: MaxLinear, Inc., Carlsbad, CA (US)

(72) Inventors: Rainer Strobel, München (DE); Avi Avraham Mansour, Givat-Shmuel (IL); Sigurd Schelstraete, Menlo Park, CA (US); Ziv Avital, Kadima (IL); Nir Palgy, Rosh Haayin (IL)

(73) Assignee: MaxLinear, Inc., Carlsbad, CA (US)

(21) Appl. No.: 19/281,504

(22) Filed: Jul. 25, 2025

Related U.S. Application Data
(60) Provisional application No. 63/676,300, filed on Jul. 26, 2024.

(51) Int. Cl. H04L 1/00; H04W 84/12

(52) U.S. Cl. CPC H04L 1/0061; H04L 1/0068; H04W 84/12

(57) ABSTRACT

An access point (AP) may include a processing device. The processing device may identify, at the AP, a first portion of a wireless local area network (WLAN) frame and a second portion of a WLAN frame, in which the first portion of the WLAN frame may include a first set of one or more codewords having a first protection level and the second portion of the WLAN frame may include a second set of one or more codewords having a second protection level. The processing device may select, at the AP, a first forward error correction (FEC) setting for the first portion of the WLAN frame to facilitate the first protection level, and select, at the AP, a second FEC setting for the second portion of the WLAN frame to facilitate the second protection level.

### RELATED APPLICATION

This application claims the benefit of U.S. Provisional Application No. 63/676,300, filed Jul. 26, 2024, the disclosure of which is incorporated herein by reference in its entirety.

The examples discussed in the present disclosure are related to enhancements to communication technology and in some instances, to latency reduction and increased reliability of WLAN transmission.

### BACKGROUND

Unless otherwise indicated herein, the materials described herein are not prior art to the claims in the present application and are not admitted to be prior art by inclusion in this section.

Institute of Electrical and Electronics Engineers (IEEE) 802.11 standards include protocols for implementing wireless local area network (WLAN) communications, including Wi-Fi®. Enhanced reliability and low latency may be used in wireless local area networks (WLANs).

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, an access point (AP) may include a processing device. The processing device may identify, at the AP, a first portion of a wireless local area network (WLAN) frame and a second portion of a WLAN frame, in which the first portion of the WLAN frame may include a first set of one or more codewords having a first protection level and the second portion of the WLAN frame may include a second set of one or more codewords having a second protection level. The processing device may select, at the AP, a first forward error correction (FEC) setting for the first portion of the WLAN frame to facilitate the first protection level, and select, at the AP, a second FEC setting for the second portion of the WLAN frame to facilitate the second protection level.

In some examples, a station (STA) may include a processing device. The processing device may identify, at the STA, a first portion of a wireless local area network (WLAN) frame and a second portion of a WLAN frame, in which the first portion of the WLAN frame may include a first set of one or more codewords having a first protection level and the second portion of the WLAN frame may include a second set of one or more codewords having a second protection level. The processing device may select, at the STA, a first forward error correction (FEC) setting for the first portion of the WLAN frame to facilitate the first protection level, and select, at the STA, a second FEC setting for the second portion of the WLAN frame to facilitate the second protection level.

In some examples, a computer-readable storage medium may include computer executable instructions that, when executed by a processing device, may cause an access point (AP) to: identify, at the AP, a first portion of a wireless local area network (WLAN) frame and a second portion of a WLAN frame, in which the first portion of the WLAN frame includes a first set of one or more codewords having a first protection level and the second portion of the WLAN frame includes a second set of one or more codewords having a second protection level. The computer executable instructions, when executed by a processing device, may cause an access point (AP) to select, at the AP, a first forward error correction (FEC) setting for the first portion of the WLAN frame to facilitate the first protection level, and select, at the AP, a second FEC setting for the second portion of the WLAN frame to facilitate the second protection level. The computer executable instructions, when executed by a processing device, may cause an access point (AP) to transmit, from the AP to a station (STA), the WLAN frame.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example alignment between Ethernet packets, low-density parity check (LDPC) codewords, and OFDM symbols.

FIG. 2 illustrates an example wireless local area network (WLAN) frame (e.g., physical layer protocol data unit (PPDU)).

FIG. 3 illustrates an example WLAN frame (e.g., PPDU).

FIG. 4 illustrates an example WLAN frame (e.g., PPDU) using different forward error correction (FEC) code rates.

FIG. 5 illustrates an example receiver request for increased protection of a frame start.

FIG. 6 illustrates an example transmitter evaluation of packet error rate (PER) to facilitate increased protection.

FIG. 7 illustrates a process flow of an access point (AP) used for WLAN unequal data protection.

FIG. 8 illustrates an example communication system for WLAN unequal data protection.

FIG. 9 illustrates a diagrammatic representation of a machine in the example form of a computing device within which a set of instructions, for causing the machine to perform any one or more of the methods discussed herein, may be executed.

FIG. 10 illustrates example convergence behavior of a WLAN receiver on a longer frame in terms of packet error rate of a 1500 byte packet.

FIG. 11 illustrates example convergence behavior of a WLAN receiver on a longer frame in terms of FEC codeword error rate of a 1500 byte packet.

FIG. 12 illustrates an example comparison between repetitions, shortening, and puncturing/shortening with reduced code rate for increasing robustness.

FIG. 13 illustrates an example legacy Wi-Fi® alignment strategy for payload up to 10,000 bytes, assuming 1 spatial stream, 80 MHz, 8 bit quadrature amplitude modulation (QAM), and a target code rate of ¾.

FIG. 14 illustrates an example alignment strategy without repetitions, up to 10000 bytes, assuming 1 spatial stream, 80 MHz, 8 bit QAM transmission, target code rate ¾.

FIG. 15 illustrates an example alignment strategy without repetitions, up to 10000 bytes, assuming 1 spatial stream, 80 MHz, 8 bit QAM transmission, target code rate ¾, and

$${ρ}_{max} = 0.7 < \frac{{K}_{FEC}}{{N}_{FEC}} = 0.75 .$$

FIG. 16 illustrates an example with 2 different effective code rates for protected frames at the frame start and other frames, using a maximum effective code rate of the protected codewords of 0.7.

FIG. 17 illustrates an example with 2 different effective code rates for protected frames at the frame start and other frames, keeping the effective code rate of the un-protected codewords at a fixed code rate of ¾ and using the extra parity for the protected codewords.

FIG. 18 illustrates example statistics for the number of retransmissions used for successful packet transmission.

FIG. 19 illustrates example latency distribution with traffic to be 80% of the PHY rate.

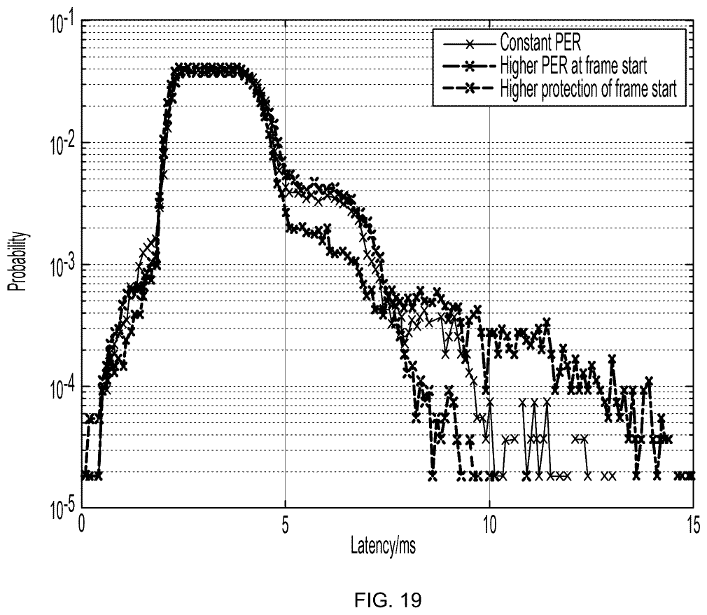

FIG. 20 illustrates example average and 99% worst-case latency for different amounts of traffic.

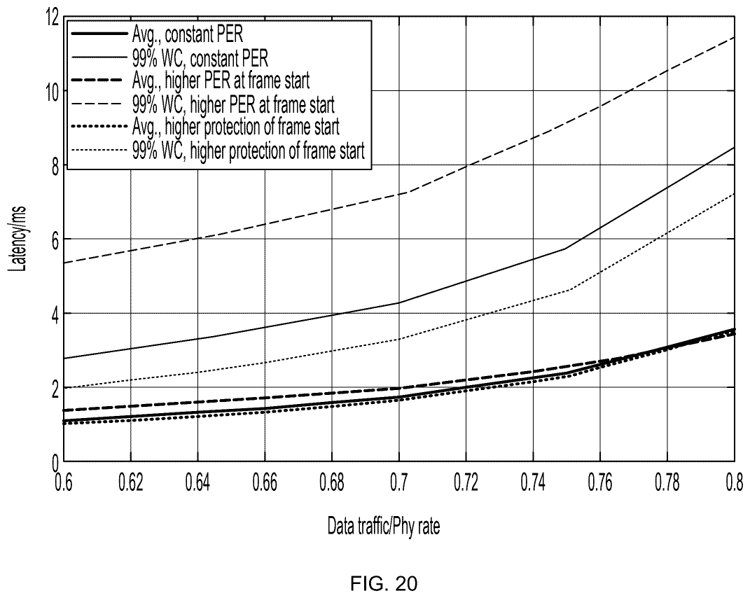

FIG. 21 illustrates an example graph of an alignment strategy.

FIG. 22 illustrates an example graph of an alignment strategy with increased shortening.

### DESCRIPTION

Larger size low density parity check (LDPC) codes may provide enhanced performance. With further framing improvements, reliability and latency may be enhanced for large physical layer protocol data units (PPDUs) and high rates.

To align the size of the data payload of a wireless local area network (WLAN) packet with the number of forward error correction (FEC) codewords and the number of orthogonal frequency division multiplexing (OFDM) symbols, a flexible alignment scheme may be used, which may distribute the available data bits and overhead from the error correction code over the OFDM symbols.

Instead of constant overhead for the codewords of the frame, the present disclosure proposes techniques to provide increased protection by using additional FEC overhead for the most vulnerable parts of the frame, e.g., the initial OFDM symbols and/or the retransmitted Ethernet packets.

The FEC overhead of the FEC codewords may be varied depending on the position in the WLAN frame. The FEC overhead may be varied by using a different number of puncturing and shortening bits per codeword or by a different LDPC code rate. In these cases, additional protection of specific portions of the frame may be achieved, while the remaining portion of the frame may have lower protection and less overhead.

Reliability may be increased by one or more of: (1) using more shortening and fewer repetitions, and/or (2) unequal overhead distribution within the frame. Specifically, better protection for the initial medium access control (MAC) protocol data units may be provided. OFDM settings used for higher rates (e.g., high modulation and coding scheme (MCS) or many carriers) may lead to a high number of repetition bits which may be inefficient. Unequal protection of the initial symbols in the frame can enhance reliability.

The choice of LDPC framing parameters may be enhanced in various ways. Selecting shortening over repetition may enhance reliability. A change in the framing rules (e.g., allowing allowing

$${N}_{CW} > ⌈ \frac{{N}_{pid}}{3888 R} ⌉ )$$

may allow for more shortening bits and fewer repetition bits. LDPC parameters may be selected to provide higher protection for the start of the payload which may have the retransmitted packets. Therefore, an unequal distribution of the puncturing and shortening bits within the frame may provide a latency improvement.

Examples of the present disclosure will be explained with reference to the accompanying drawings.

Enhanced reliability and low latency may be facilitated for wireless local area networks (WLANs). This disclosure includes methods to reduce latency and increase reliability of WLAN transmission based on techniques to provide different levels of protection for the portions of the WLAN frame which may use higher protection due to (1) sensitive content, e.g., retransmitted packets or (2) due to a temporary degradation of the signal quality, or for any other reason.

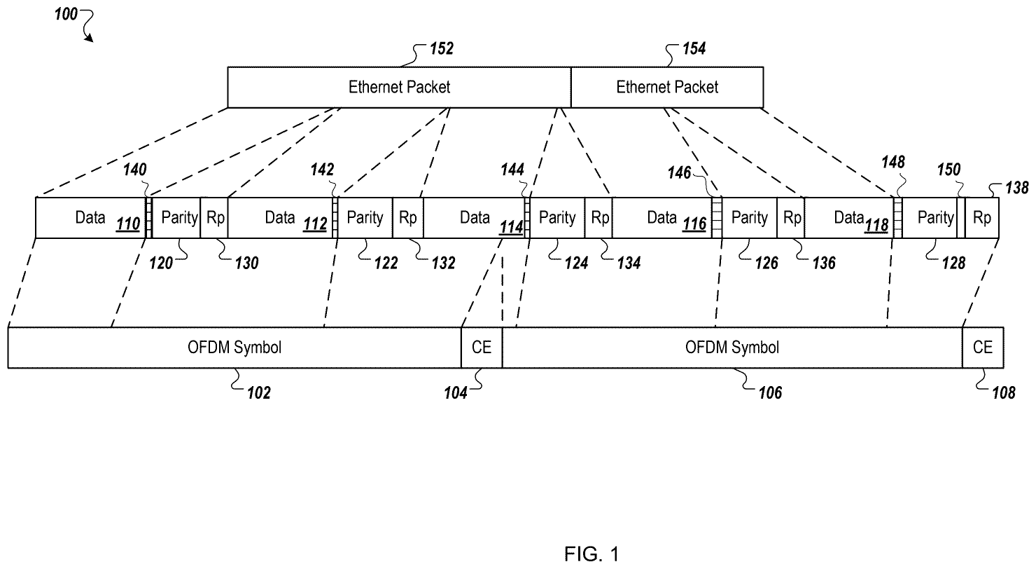

As illustrated in the WLAN packet diagram 100 in FIG. 1, WLAN packets, e.g., when transmitting high data rates, may span over multiple orthogonal frequency division multiplexing (OFDM) symbols 102, 106 and may contain Ethernet packets 152, 154. The OFDM symbols 102 and 106 may include channel estimation (CE) fields 104, 108. The Ethernet packets 152, 154 may include one or more codewords. The codewords may include data fields 110, 112, 114, 116, 118, parity fields 120, 122, 124, 126, 128, repetition fields 130, 132, 134, 136, 138, shortening 140, 142, 144, 146, 148, and puncturing 150.

Within the WLAN packet, the reception quality may change, e.g., due to receiver adaptation and convergence (i.e., lower quality on the first symbols). Furthermore, the protection level within the WLAN packet may not be constant. Retransmitted Ethernet packets, which may be at the start of the WLAN packet, may use higher protection to keep latency low.

WLAN forward error correction (FEC) may keep the FEC overhead constant throughout the WLAN packet. To match the payload size with the transmitted bits of the OFDM symbols, repetitions of payload bits (e.g., repetition fields 130, 132, 134, 136, 138) may be used. Puncturing 150 and shortening 140, 142, 144, 146, 148 of the FEC may be used in addition.

While repetitions (e.g., repetition fields 130, 132, 134, 136, 138) and shortening 140, 142, 144, 146, 148 may increase the reliability, puncturing 150 may reduce the reliability. Rate matching strategy may use repetitions (e.g., repetition fields 130, 132, 134, 136, 138) (which may provide a small reliability improvement), while puncturing 150 and shortening 140, 142, 144, 146, 148 may be balanced to keep the FEC coding gain constant.

This disclosure provides methods to protect vulnerable portions of the WLAN packet, which may enhance latency and reliability. This may be performed by having additional protection of initial OFDM symbols, which may carry latency sensitive traffic.

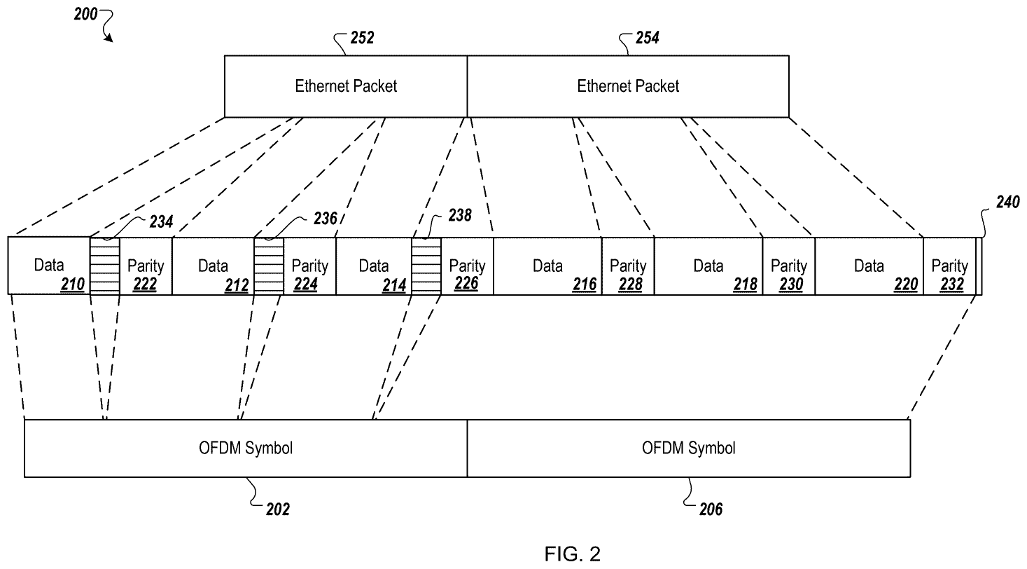

As illustrated in the WLAN packet diagram 200 in FIG. 2, Ethernet packets 252, 254 may span one or more OFDM symbols 202, 206. The codewords may include data fields 210, 212, 214, 216, 218, 220, parity fields 222, 224, 226, 228, 230, 232, shortening 234, 236, 238 and puncturing 240. In this example, there may be increased protection at the frame start. That is, shortening bits may be moved to the frame start, puncturing bits may be used at the frame end, and repetition bits may be minimized. The codewords near the frame start may be high-reliability codewords (e.g., having a higher protection level) while the codewords near the frame end may be codewords having a lower protection level.

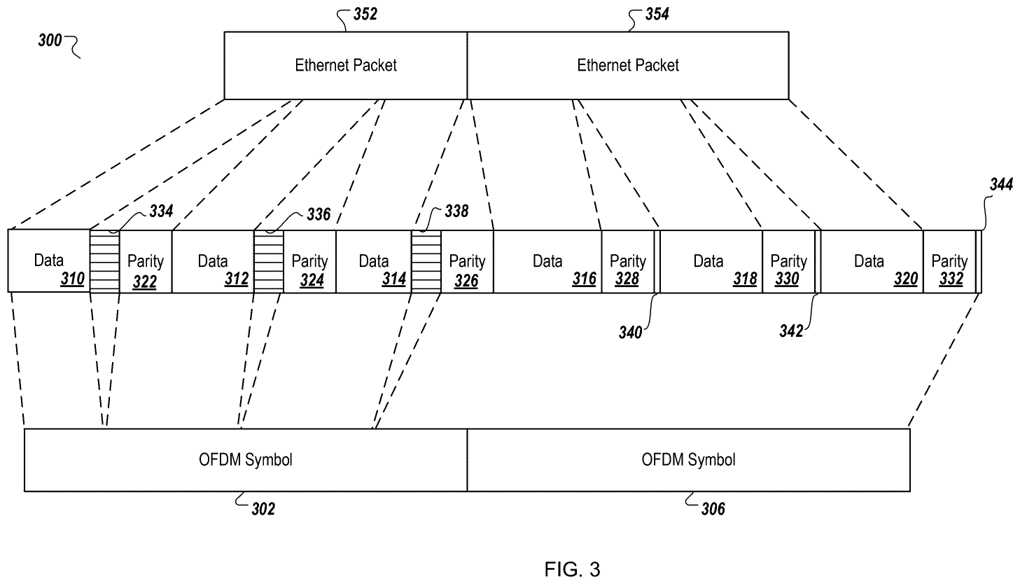

In another example, as illustrated in the WLAN packet diagram 300 in FIG. 3, Ethernet packets 352, 354 may span one or more OFDM symbols 302, 306. The codewords may include data fields 310, 312, 314, 316, 318, 320, parity fields 322, 324, 326, 328, 330, 332, shortening 334, 336, 338, and puncturing 340, 342, 344. The codewords near the frame start may be high-reliability codewords (e.g., having a higher protection level) while the codewords near the frame end may be codewords having a lower protection level.

In an example, an access point (AP) may include a processing device. The processing device may identify, at the AP, a first portion of a WLAN frame and a second portion of a WLAN frame. The first portion of the WLAN frame may include a first set of one or more codewords having a first protection level and the second portion of the WLAN frame may include a second set of one or more codewords having a second protection level. The processing device may select, at the AP, a first FEC setting for the first portion of the WLAN frame to facilitate the first protection level. The processing device may select, at the AP, a second FEC setting for the second portion of the WLAN frame to facilitate the second protection level.

The FEC overhead may be determined by the FEC code rate (the ratio between number of data bits of the FEC codeword K_{fec} and the codeword size N_{fec}), which may be adjusted by one or more of puncturing (i.e., reducing the number of overhead bits of the codeword), shortening (i.e., reducing the number of data bits of the codeword) and repetitions (i.e., of the data bits of the codeword).

The first FEC setting (e.g., for the first portion of the WLAN frame) may include one or more of an increased number of shortening bits or a reduced number of puncturing bits when compared to the second FEC setting (e.g., for the second portion of the WLAN frame). That is, additional protection of different parts of the frame may be achieved by changing the puncturing and shortening settings of the different FEC codewords. Alternatively or in addition, additional protection of different parts of the frame may be achieved by using different low density parity check (LDPC) code rates within the frame, e.g., a lower code rate for more sensitive data.

In some examples, short packets and repetitions may be used to adjust the FEC settings with the OFDM settings and the payload size. Bit repetitions may be used to fill up the OFDM symbol, but may provide a minor reliability gain, e.g., when a few bits of the FEC codeword may be repeated. Therefore, the processing device may be operable to align one or more of the FEC settings, OFDM settings, or payload size without using repetitions.

When the FEC coding gain is kept constant throughout the frame, packet error rate-based link adaptation may be simplified without an enhancement in reliability and/or latency. Therefore, the first FEC setting (e.g., for the first portion of the WLAN frame) may have a lower FEC code rate when compared to the second FEC setting (e.g., for the second portion of the WLAN frame).

Varying the FEC overhead may affect the receiver side, e.g., to overcome a reduced reception quality at the beginning of the frame due to receiver convergence. Hereby, the receiver may request additional protection (in terms of overhead percentage or dBs of additional margin) for specific symbols or FEC codewords, or the transmitter may observe a degradation in the frame start from negative acknowledgements and autonomously decide to protect the frame start.

The transmitter may also perform improved protection of specific parts of the frame due to the contents. The first portion of the WLAN frame may include one or more retransmitted data units. Therefore, sensitive traffic (e.g., re-transmitted packets) may be protected with additional FEC overhead to reduce latency. The probability of a second retransmission may be reduced, and thus the worst-case or tail latency may be improved.

The first symbols may have additional protection because the first symbols may suffer from timing and equalizer convergence effects. The additional protection may increase throughput. Consequently, the link settings may not be dominated by the few weakest symbols at the start of the frame, but the FEC overhead and the reception quality may be matched for the frame.

Increased robustness for specific parts of the WLAN frame, e.g., the first OFDM symbols of the frame may be obtained. For this reason, a WLAN frame and the frame alignment method is provided.

### FEC Scheme and Frame Format

A WLAN frame (or e.g., a physical layer protocol data unit (PPDU)) may include one or more OFDM symbols with a preamble at the beginning and padding at the end. Some of the framing parameters may include: (1) Number of OFDM symbols:

$${N}_{SYM} = ⌈ \frac{{N}_{PLD}}{{N}_{DBPS}} ⌉$$

in which N_{PLD} may be N_{byte,packet}·8+16 and N_{DBPS} may be the number of data bits per OFDM symbol (2) Number of LDPC codewords:

$${N}_{cw} = ⌈ \frac{{N}_{pld}}{3888 R} ⌉$$

(if N_{avbits}>3888) in which N_{avbits} may be the number of available bits of the OFDM symbols and R may be the code rate (3) Shortening: Nₛₕᵣₜ=max (0, (N_{CW}L_{LDPC}R)−N_{PLD}) in which L_{LDPC} may be the LDPC codeword length in bits (4) Puncturing: N_{punc}=max (0, (N_{CW}L_{LDPC})−N_{PLD}−Nₛₕᵣₜ), and (5) Repetitions:

$${N}_{rep} = max ( 0 , {N}_{avbits} - {N}_{CW} {L}_{LDPC} ( 1 - R ) - {N}_{PLD} ) .$$

The number of bits in a PPDU may depend on the modulation format and the number of symbols. The settings may include: (i) number of data carriers K (e.g., K=980 for 80 MHz, K=1960 for 160 MHz or K=3920 for 320 MHz), (ii) number of spatial streams L (L=1, up to the number of antennas), and (iii) constellation size b (1, 2, 4, 6, 8, 10 12 bit).

Wi-Fi® may use LDPC codes for forward error correction. There are various configuration parameters for LDPC codes. The LDPC code size may be e.g., 648 bits, 1296 bits, 1944 bits, 3888 bits, or the like. The LDPC code rate may be

$$ρ = \frac{{K}_{FEC}}{{N}_{FEC}} :$$

½, ⅔, ¾, ⅚ in which K_{FEC} may be the LDPC payload size and N_{FEC} may be the LDPC codeword size.

The combination of constellation size (b) and LDPC code rate Kfec/Nfec may determine the MCS. The MCS may have a specific effective rate (in bits per carrier), which may be given by

$${r}_{eff} = b \frac{{K}_{fec}}{{N}_{fec}} .$$

Specific combinations are allowed (see Error! Reference source not found.).

TABLE 1
Available MCS in Wi-Fi ® 7 (IEEE 802.11 be)

| MCS | 0 | 1 | 2 | 3 | 4 | 5 | 6 | 7 | 8 | 9 | 10 | 11 | 12 | 13 |
|---|---|---|---|---|---|---|---|---|---|---|---|---|---|---|
| K/N | ½ | ½ | ¾ | ½ | ¾ | ⅔ | ¾ | ⅚ | ¾ | ⅚ | ¾ | ⅚ | ¾ | ⅚ |
| b | 1 | 2 | 2 | 4 | 4 | 6 | 6 | 6 | 8 | 8 | 10 | 10 | 12 | 12 |
| r_{eff} | 0.5 | 1 | 1.5 | 2 | 3 | 4 | 4.5 | 5 | 6 | 6.67 | 7.5 | 8.33 | 9 | 10 |

In some cases, there may be more LDPC codewords than OFDM symbols, for example, with 80 megahertz (MHz), 1 spatial stream, and 8-bit QAM (MCS 8 or 9), each OFDM symbol may carry 980×8=7840 bits or 4 LDPC codewords.

The payload of a WLAN transmission may include Ethernet packets. Ethernet packets may have various sizes. Traffic statistics indicate a common length of 1500 bytes (12000 bits) or 10000 bytes (80000 bits). The maximum size of WLAN frames may contain 1 megabyte of data. To increase efficiency, multiple Ethernet packets may be combined to a larger WLAN frame.

A physical layer (PHY) frame or PPDU may include a physical layer service data unit (PSDU). PSDUs may include an aggregate MAC protocol data unit (A-MPDU). The A-MPDU may include subframes with 1 MPDU each. The MPDUs may include one MAC service data unit (MSDU) or multiple (A-MSDU), with one or more Ethernet packets. The present disclosure may be applicable to other payload arrangements.

Different protection levels within the WLAN frame may be achieved by distributing repeated bits unequally over the frame or by using different effective FEC code rates with a change of puncturing and shortening, as shown in FIG. 2 or 3.

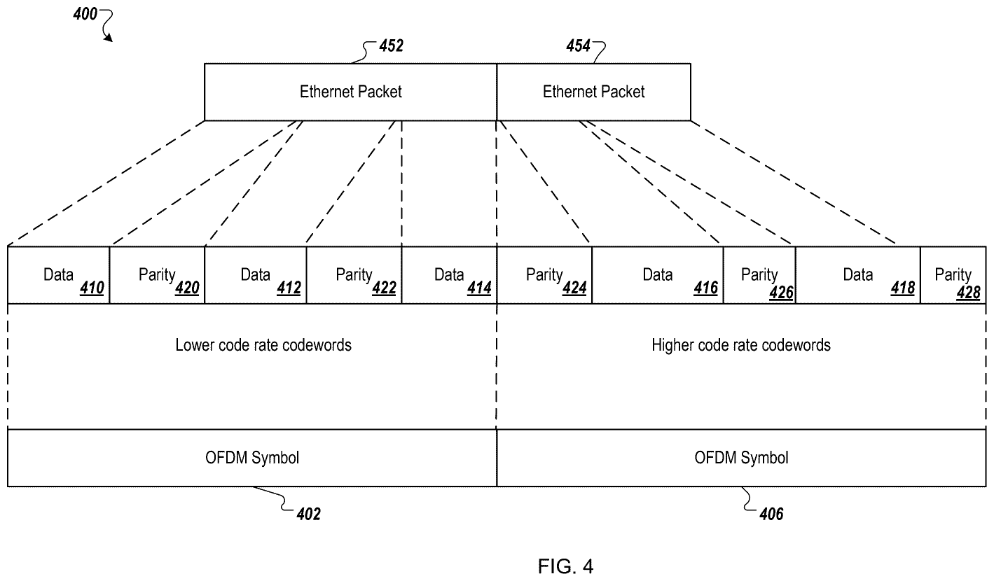

In addition, the FEC code rate may be changed. An example is given in FIG. 4 with a low code rate for the first codewords (e.g., for a first portion of the WLAN frame) and a higher code rate for the later codewords (e.g., for a second portion of the WLAN frame). This change in FEC code rate may allow for larger changes of the effective code rate and thus, an increase of robustness.

As illustrated in the WLAN packet diagram 400 in FIG. 4, Ethernet packets 452, 454 may span one or more OFDM symbols 402, 406. The codewords may include data fields 410, 412, 414, 416, 418 and parity fields 420, 422, 424, 426, 428. The first portion of the WLAN frame (e.g., including data fields 410, 412, 414 and parity fields 420, 422) may include lower code rate codewords (e.g., when compared to a baseline code rate). The second portion of the WLAN frame (e.g., including data fields 416, 418 and parity fields 424, 426, 428) may include higher rate codewords (e.g., when compared to a baseline code rate). The code rate for the first portion of the WLAN frame may be lower when compared to the code rate for the second portion of the WLAN frame.

### Communication Protocol

Information exchange between transmitter and receiver may be used to implement unequal data protection. In one example, the overhead setting for unequal protection may be determined by the receiver and communicated to the transmitter. That is, the overhead setting for unequal protection may be determined by the STA and communicated to the AP when the AP is transmitting, or the overhead setting for unequal protection may be determined by the AP and communicated to the STA when the STA is transmitting.

In another example, the overhead settings may be determined by the transmitter (e.g., the AP when the AP is transmitting or the STA when the STA is transmitting) based on an indication from the receiver (e.g., the STA when the STA is receiving or the AP when the AP is receiving) and communicated to the receiver (e.g., the STA when the STA is receiving or the AP when the AP is receiving) in the packet header.

In another example, the settings may be identified by the transmitter (e.g., the AP when the AP is transmitting or the STA when the STA is transmitting) and communicated to the receiver (e.g., the STA when the STA is receiving or the AP when the AP is receiving) in the packet header.

Communication from Receiver to Transmitter

The information about unequal protection may be exchanged between the transmitter (e.g., the AP when the AP is transmitting or the STA when the STA is transmitting) and the receiver (e.g., the STA when the STA is receiving or the AP when the AP is receiving). Fixed rules may determine the number of puncturing, shortening, and/or repetition bits per codeword from the OFDM symbol settings, the MCS, and/or the payload size.

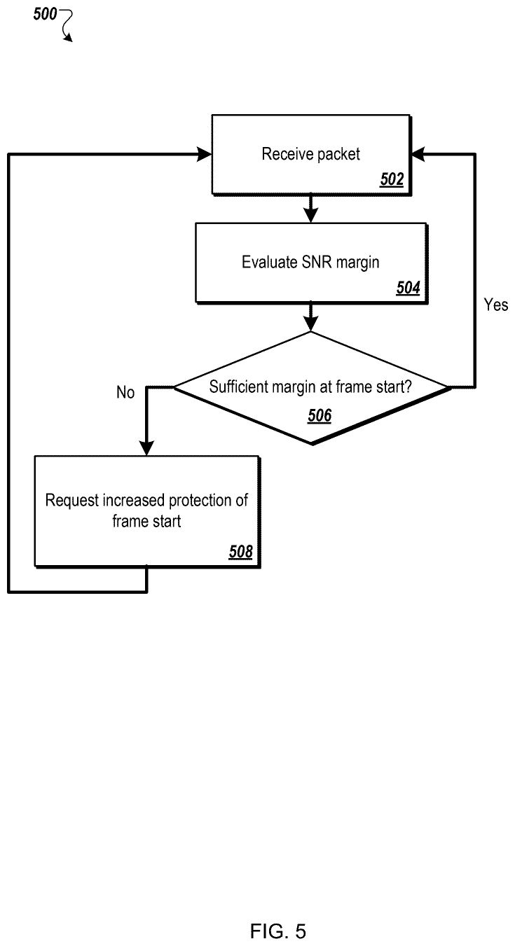

A processing device may receive, e.g., at the AP from a STA (when the AP is the transmitter and the STA is the receiver), a request for protection of the first portion of the WLAN frame. In one example, the receiver (e.g., the STA in this example) may request protection of certain OFDM symbols of the WLAN packet that may use additional margin (e.g., in the start of the frame due to convergence effects). An example is shown in FIG. 5. This may be performed per packet, e.g., in the block acknowledgement message or on a regular basis on request from the AP, e.g., in the MCS feedback message or as a static setting in the capabilities message.

As illustrated in the flow diagram 500 in FIG. 5, a receiver (e.g., a STA) may receive a packet, as shown by the operation 502. The receiver may evaluate the signal-to-noise ratio (SNR) margin, as shown by the operation 504. The receiver may determine when there is a sufficient margin at the frame start, as shown by operation 506. When there is a sufficient margin at the frame start, the receiver may continue to receive an additional packet, as shown by operation 502. When there is not a sufficient margin at the frame start, the receiver may request increased protection of the frame start, as shown by operation 508. After requesting increased protection of the frame start, the receiver may continue to receive an additional packet, as shown by operation 502.

The protection request from the receiver may include the number of OFDM symbols and the position of the OFDM symbols (e.g., at the start or the end of the frame) to be protected and the level of additional protection used for these symbols. In some examples, the first portion of the WLAN frame (e.g., the portion to receive additional protection) may include one or more additional orthogonal frequency division multiplexing (OFDM) symbols when compared to a minimum number of OFDM symbols.

The processing device may identify, e.g., at the transmitter such as the AP, receiver convergence based on an increased error rate in the first portion of the WLAN frame (e.g., the portion of the WLAN frame to have increased protection). The number of OFDM symbols or derived parameters, e.g., the number of PHY bits N_{sym} N_{cbps} may be appropriate for PHY related effects, e.g. receiver convergence.

In another example, the number of payload bytes to protect may be determined, e.g., in terms of the number of FEC codewords or the payload packet size. The protection level requested may be in terms of an overhead percentage (e.g., the effective code rate

$$ρ = \frac{{K}_{FEC}}{{N}_{FEC}} ) .$$

In another example, the protection level may be communicated in terms of SNR margin (e.g., in dB).

### Transmitter-Side Convergence Evaluation

In one example, the transmitter may evaluate receiver convergence from the block acknowledgement message. Observing an increased packet error probability in the initial packets of the frame may indicate convergence effects of the receiver. Based on a statistical evaluation of the packet errors, dependent on the position in the frame, the transmitter may determine the number of codewords that may have increased protection as well as the protection level used. In addition, the transmitter knowledge about retransmitted packets may be used for the decision to enable a higher protection of the initial packets of the frame.

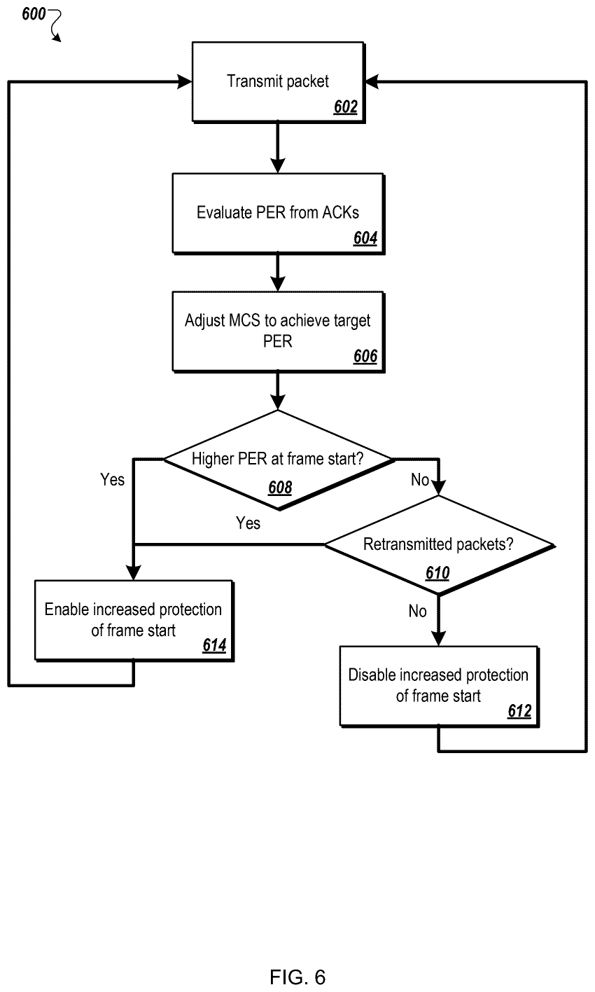

As illustrated in the process flow 600 of FIG. 6, the transmitter may transmit a packet, as shown in operation 602. The transmitter may evaluate the packet error rate from the acknowledgments (e.g., a block acknowledgment message), as shown in operation 604. The transmitter may adjust the modulation and coding scheme to achieve a target packet error rate, as shown in operation 606. When the WLAN frame has a higher packet error rate at the frame start, as shown in operation 608, then increased protection of the frame start may be enabled, as shown in operation 614. The transmitter may continue to transmit another packet, as shown in operation 602. When the WLAN frame does not have a higher packet error rate at the frame start, as shown in operation 608, then the transmitter may determine whether there are retransmitted packets, as shown in operation 610. When there are retransmitted packets, then increased protection of the frame start may be enabled, as shown in operation 614, and the transmitter may continue to transmit another packet, as shown in operation 602. When there are not retransmitted packets, then the transmitter may disable increased protection of the frame start, as shown in operation 612, and the transmitter may continue to transmit another packet, as shown in operation 602.

Communication from Transmitter to Receiver

The processing device may communicate, from the transmitter (e.g., an AP) to a receiver (e.g., a STA), one or more of a number of OFDM symbols having the first protection level, a position of OFDM symbols having the first protection level, a number of the first set of the one or more codewords having the first protection level, a position of the first set of the one or more codewords having the first protection level, a code rate identifying an additional overhead for the first portion of the WLAN frame when compared to the second portion of the WLAN frame, or an indication for frame alignment.

When using increased protection for a WLAN frame, the frame configuration may be known to the transmitter and receiver, e.g., using predefined rules or by communication from the transmitter to the receiver, e.g., in the frame header.

Various settings may be communicated in the frame header. For example, selected rules may be communicated to match one or more of FEC settings, payload size, and/or OFDM symbol size (e.g., using 1 bit). One or more of puncturing, repetition, and/or shortening may be used to match one or more of FEC settings, payload size, and/or OFDM symbol size. Alternatively or in addition, puncturing and/or shortening may be used to match one or more of FEC settings, payload size, and/or OFDM symbol size without using puncturing.

In addition or alternatively, the overall overhead of the frame may be communicated in the frame header. The length of the frame in time (e.g., the number of OFDM symbols) may be communicated to provide the overall overhead of the frame.

In addition or alternatively, the number and/or position of protected symbols may be communicated in the frame header. The frame start and/or frame end may be e.g., fixed in a standard or communicated using e.g., 1 bit. Alternatively or in addition, the number of FEC codewords and/or OFDM symbols and/or payload size with a higher protection level compared to a baseline level of protection may be communicated in the frame header or may be pre-defined.

The additional margin of the protected codewords may be communicated in the frame header. The additional margin may be derived from the frame settings (e.g., regular codewords overhead may be determined from MCS while additional overhead, as available by matching the FEC settings with the number of OFDM symbols, may be provided to the protected frames). Alternatively or in addition, the additional margin may be communicated by the effective code rate of the protected codewords.

In addition or alternatively, a set of pre-defined rules may be used to distribute the additional overhead in which the transmitter (e.g., the AP) may select from. The selected rule may be communicated to the receiver (e.g., the STA). The pre-defined rules may include e.g., using the maximum code rate (according to the MCS) for the unprotected codewords and additional parity, as provided from the frame alignment, for the protected codewords. Alternatively or in addition, a fixed maximum code rate (which may be lower than the code rate provided by the MCS) may be used for the protected codewords. When the overall overhead is lower than the maximum code rate, then the overhead may be distributed equally for the codewords. In addition or alternatively, the protected codewords may use the maximum code rate and the unprotected codewords may use the remaining overhead.

### EXAMPLES

In one example, a method may provide unequal protection within the WLAN frame by the use of different FEC settings for different parts of the frame. The method may include increasing the number of shortening bits and/or reducing the number of puncturing bits for the protected codewords at a specific location of the frame. In one example, the initial frame may have increased protection. In another example, the last frames may have increased protection. In another example, the symbols containing retransmitted data units may have increased protection. In another example, the symbols containing sensitive data may have increased protection.

In another example, a method may use shortening/puncturing instead of repetitions to align one or more of FEC settings, OFDM settings and/or payload size. In one example, the method may include increasing robustness by transmitting one or more additional OFDM symbols (more than the minimum number). In another example, the method may use a lower FEC code rate for codewords with higher protection. In another example, the method may communicate a request for increased protection of certain parts of the frame, e.g., the frame start, from the receiver to the transmitter.

In another example, a method may use puncturing and/or shortening for frame alignment instead of repetitions and/or shortening (e.g., for packets without un-equal FEC overhead). The method may include increasing robustness by transmitting extra OFDM symbols.

In another example, a method may include a communication protocol to communicate the type of frame alignment used for the WLAN frame from the transmitter to the receiver. The communication protocol to the receiver may include a request for a certain type of frame alignment (e.g., puncturing and/or shortening or puncturing and/or repetition and/or shortening) from the receiver.

In another example, a WLAN transmitter may identify receiver convergence issues from the transmitter side by observing an increased error rate at the frame start at the transmitter side by inspecting the position of retransmitted data unit.

In another example, a method may include communicating information about unequal data protection (e.g., puncturing and/or shortening; or puncturing and/or repetitions and/or shortening) from the transmitter to the receiver. The method may include communicating the number and position of increased protection OFDM symbols or codewords. The additional overhead may be provided in terms of code rate. The indication for the frame alignment scheme may be provided.

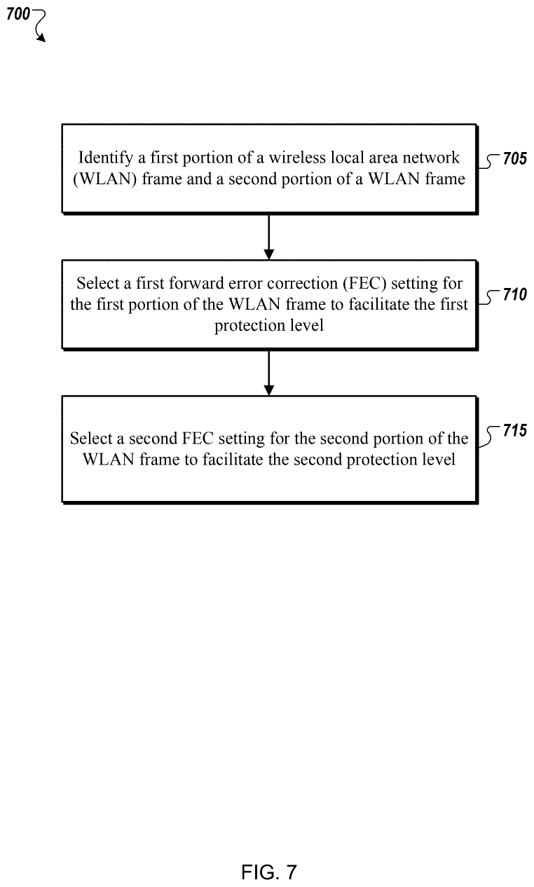

FIG. 7 illustrates a process flow of an example method 700 of WLAN unequal data protection, in accordance with at least one example described in the present disclosure. The method 700 may be arranged in accordance with at least one example described in the present disclosure.

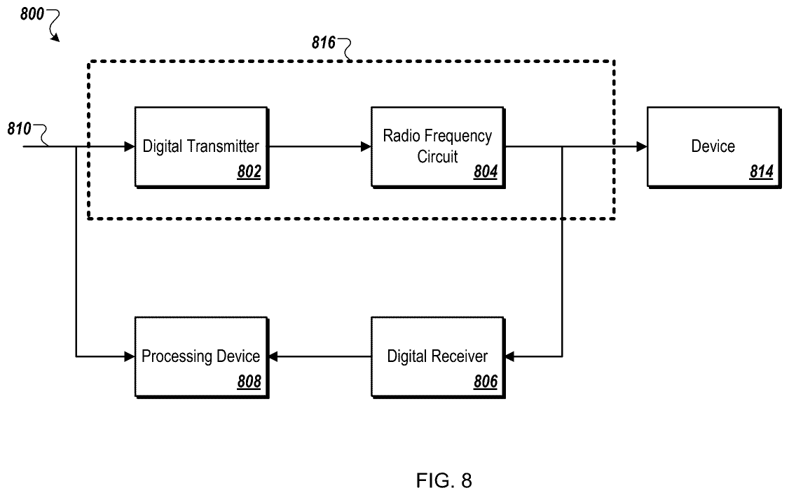

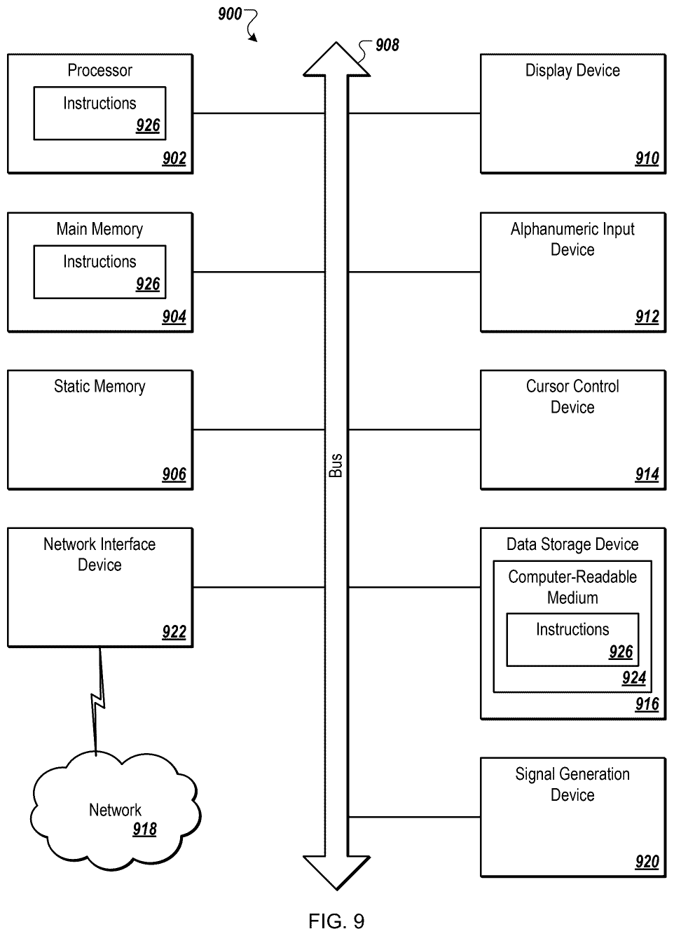

The method 700 may be performed by processing logic that may include hardware (circuitry, dedicated logic, etc.), software (such as is run on a computer system or a dedicated machine), or a combination of both, which processing logic may be included in the processing device 902 of FIG. 9, the communication system 800 of FIG. 8, or another device, combination of devices, or systems.

The method 700 may begin at block 705 where the processing logic may identify, at the AP, a first portion of a WLAN frame and a second portion of a WLAN frame. The first portion of the WLAN frame may include a first set of one or more codewords having a first protection level and the second portion of the WLAN frame may include a second set of one or more codewords having a second protection level.

At block 710, the processing logic may select, at the AP, a first FEC setting for the first portion of the WLAN frame to facilitate the first protection level.

At block 715, the processing logic may select, at the AP, a second FEC setting for the second portion of the WLAN frame to facilitate the second protection level.

Modifications, additions, or omissions may be made to the method 700 without departing from the scope of the present disclosure. For example, in some examples, the method 700 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 8 illustrates a block diagram of an example communication system 800 for WLAN unequal data protection, in accordance with at least one example described in the present disclosure. The communication system 800 may include a digital transmitter 802, a radio frequency circuit 804, a device 814, a digital receiver 806, and a processing device 808. The digital transmitter 802 and the processing device may receive a baseband signal via connection 810. A transceiver 816 may include the digital transmitter 802 and the radio frequency circuit 804.

In some examples, the communication system 800 may include a system of devices that may communicate with one another via a wired or wireline connection. For example, a wired connection in the communication system 800 may include one or more Ethernet cables, one or more fiber-optic cables, and/or other similar wired communication mediums. Alternatively, or additionally, the communication system 800 may include a system of devices that may communicate via one or more wireless connections. For example, the communication system 800 may include one or more devices that may transmit and/or receive radio waves, microwaves, ultrasonic waves, optical waves, electromagnetic induction, and/or similar wireless communications. Alternatively, or additionally, the communication system 800 may include combinations of wireless and/or wired connections. In these and other examples, the communication system 800 may include one or more devices that may obtain a baseband signal, perform one or more operations to the baseband signal to generate a modified baseband signal, and transmit the modified baseband signal, such as to one or more loads.

In some examples, the communication system 800 may include one or more communication channels that may communicatively couple systems and/or devices included in the communication system 800. For example, the transceiver 816 may be communicatively coupled to the device 814.

In some examples, the transceiver 816 may obtain a baseband signal. For example, as described herein, the transceiver 816 may generate a baseband signal and/or receive a baseband signal from another device. In some examples, the transceiver 816 may transmit the baseband signal. For example, upon obtaining the baseband signal, the transceiver 816 may transmit the baseband signal to a separate device, such as the device 814. Alternatively, or additionally, the transceiver 816 may modify, condition, and/or transform the baseband signal in advance of transmitting the baseband signal. For example, the transceiver 816 may include a quadrature up-converter and/or a digital to analog converter (DAC) that may modify the baseband signal. Alternatively, or additionally, the transceiver 816 may include a direct radio frequency (RF) sampling converter that may modify the baseband signal.

In some examples, the digital transmitter 802 may obtain a baseband signal via connection 810. In some examples, the digital transmitter 802 may up-convert the baseband signal. For example, the digital transmitter 802 may include a quadrature up-converter to apply to the baseband signal. In some examples, the digital transmitter 802 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 802.

In some examples, the transceiver 816 may include one or more subcomponents that may be used in preparing the baseband signal and/or transmitting the baseband signal. For example, the transceiver 816 may include an RF front end (e.g., in a wireless environment) which may include a power amplifier (PA), a digital transmitter (e.g., 802), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 804) of the transceiver 816 may be synchronized with the resource controller via the S-plane device, which may contribute to high-accuracy timing with respect to a reference clock.

In some examples, the transceiver 816 may obtain the baseband signal for transmission. For example, the transceiver 816 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 816 may generate a baseband signal for transmission. In these and other examples, the transceiver 816 may transmit the baseband signal to another device, such as the device 814.

In some examples, the device 814 may receive a transmission from the transceiver 816. For example, the transceiver 816 may transmit a baseband signal to the device 814.

In some examples, the radio frequency circuit 804 may transmit the digital signal received from the digital transmitter 802. In some examples, the radio frequency circuit 804 may transmit the digital signal to the device 814 and/or the digital receiver 806. In some examples, the digital receiver 806 may receive a digital signal from the RF circuit and/or send a digital signal to the processing device 808.

In some examples, the processing device 808 may be a standalone device or system, as illustrated. Alternatively, or additionally, the processing device 808 may be a component of another device and/or system. For example, in some examples, the processing device 808 may be included in the transceiver 816. In instances in which the processing device 808 is a standalone device or system, the processing device 808 may communicate with additional devices and/or systems remote from the processing device 808, such as the transceiver 816 and/or the device 814. For example, the processing device 808 may send and/or receive transmissions from the transceiver 816 and/or the device 814. In some examples, the processing device 808 may be combined with other elements of the communication system 800.

FIG. 9 illustrates a diagrammatic representation of a machine in the example form of a computing device 900 within which a set of instructions, for causing the machine to perform any one or more of the methods discussed herein, may be executed. The computing device 900 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a LAN, an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 900 includes a processing device (e.g., a processor 902), a main memory 904 (e.g., read-only memory (ROM), flash memory, dynamic random access memory (DRAM) such as synchronous DRAM (SDRAM)), a static memory 906 (e.g., flash memory, static random access memory (SRAM)) and a data storage device 916, which communicate with each other via a bus 908.

Processing device 902 represents one or more general-purpose processing devices such as a microprocessor, central processing unit, or the like. More particularly, the processing device 902 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also include one or more special-purpose processing devices such as an application specific integrated circuit (ASIC), a field programmable gate array (FPGA), a digital signal processor (DSP), network processor, or the like. The processing device 902 is configured to execute instructions 926 for performing the operations and steps discussed herein.

The computing device 900 may further include a network interface device 922 which may communicate with a network 918. The computing device 900 also may include a display device 910 (e.g., a liquid crystal display (LCD) or a cathode ray tube (CRT)), an alphanumeric input device 912 (e.g., a keyboard), a cursor control device 914 (e.g., a mouse) and a signal generation device 920 (e.g., a speaker). In at least one example, the display device 910, the alphanumeric input device 912, and the cursor control device 914 may be combined into a single component or device (e.g., an LCD touch screen).

The data storage device 916 may include a computer-readable storage medium 924 on which is stored one or more sets of instructions 926 embodying any one or more of the methods or functions described herein. The instructions 926 may also reside, completely or at least partially, within the main memory 904 and/or within the processing device 902 during execution thereof by the computing device 900, the main memory 904 and the processing device 902 also constituting computer-readable media. The instructions may further be transmitted or received over a network 918 via the network interface device 922.

While the computer-readable storage medium 924 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

### EXAMPLES

The following provide examples of the performance characteristics according to the present disclosure.

### Example 1

### Receiver Convergence

There may be variable signal quality within a WLAN frame (e.g., a PPDU). The signal quality within a PPDU may, due to receiver convergence, have a high error rate at the frame state (when compared to the remainder of the PPDU). A small penalty of 0.5 to 1 dB may cause an increase of errors. In addition, some of the content of the frame may use increased protection e.g., for retransmitted packets.

Wi-Fi® receivers may have various adaptive elements, e.g., for timing and/or clock recovery and/or receive equalization. The Wi-Fi® receivers may be initialized with the packet preamble, but further fine-tuning of the Wi-Fi® receiver may occur throughout the packet.

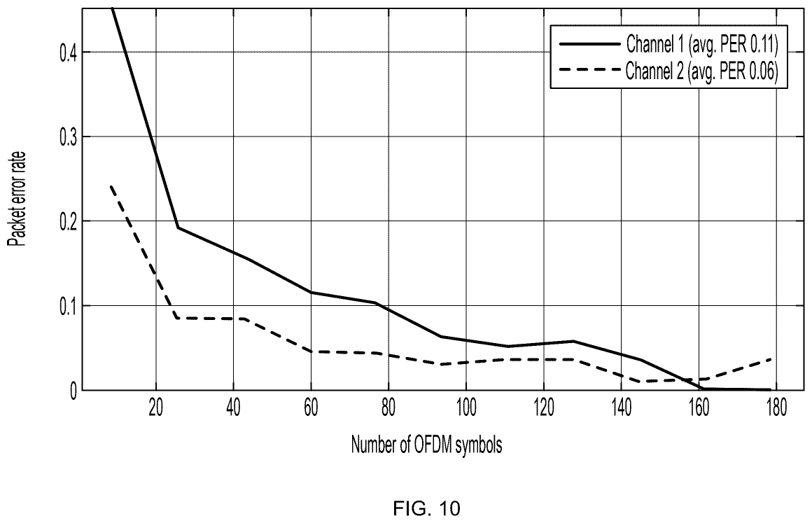

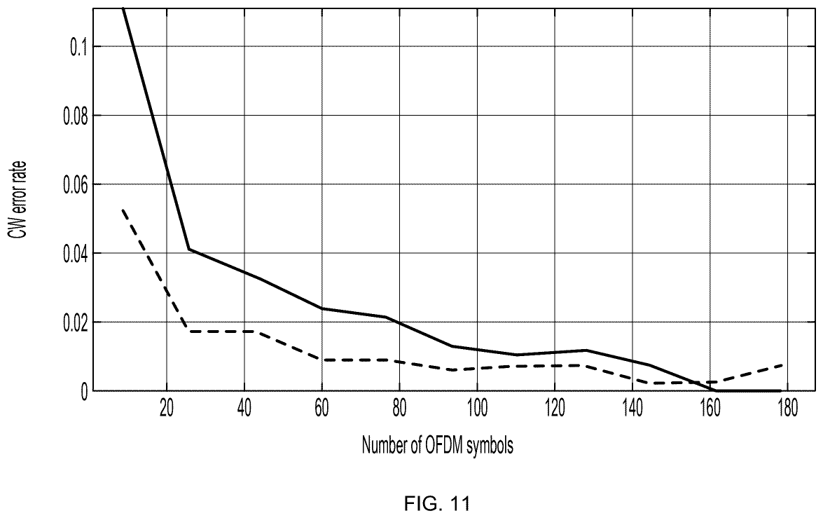

An example is shown in FIGS. 10 and 11. The data was derived from a beamforming transmission from a 2-antenna AP to a STA with 2 receive (RX) antennas and 2 spatial streams. 2× long training field (LTF), and an minimum mean squared error (MMSE)-equalizer (initialization) and least mean squares (LMS) update were used.

As shown in FIG. 10, for channel 1 having an average packet error rate of 0.11, the packet error rate was higher for approximately the first 20 OFDM symbols when compared to the remainder of the frame. For channel 2 having an average packet error rate of 0.06, the packet error rate was similarly higher for approximately the first 20 OFDM symbols when compared to the remainder of the frame.

As shown in FIG. 11, for channel 1 having an average packet error rate of 0.11, the codeword error rate was higher for approximately the first 20 OFDM symbols when compared to the remainder of the frame. Similarly, for channel 2 having an average packet error rate of 0.06, the codeword error rate was higher for approximately the first 20 OFDM when compared to the remainder of the frame.

While the average codeword error rate, and thus, the packet error rate, were in the range, the errors were not distributed equally in the packet. Most of the errors were at the start of the packet. The SNR degradation associated with the increase packet error rate at the frame start was small, e.g., around 0.5-1 dB in the example shown in FIGS. 10 and 11, but still this led to a latency increase.

### Example 2

### Overhead-Robustness Trade-Off

Different options may increase robustness of the OFDM symbols and/or the FEC codewords. One method is repetition of specific data bits which may provide higher robustness for specific bits, but limited gain for other bits. On the FEC codeword level, robustness may be increased by shortening. Hereby, the code rate may be reduced, but the codeword length reduced, too.

Repetitions and/or shortening may be used to decrease the packet error rate at the cost of a higher overhead. The effective coding rate may be provided by:

$${R}_{eff} = \frac{R {L}_{LDPC} - \frac{{N}_{shrt}}{{N}_{CW}}}{{L}_{LDPC} - \frac{{N}_{shrt}}{{N}_{CW}} - \frac{{N}_{punc}}{{N}_{CW}} + \frac{{N}_{rep}}{{N}_{CW}}}$$

in which Nₛₕᵣₜ=max (0, (N_{CW}L_{LDPC}R)−N_{PLD}), N_{punc}=max (0, (N_{CW}L_{LDPC})−N_{PLD}−Nₛₕᵣₜ), and Nᵣₑₚ=max (0, N_{avbits}−N_{CW}L_{LDPC} (1−R)−N_{PLD}).

Therefore, shortening may be more efficient than bit repetitions to increase robustness. In addition, for an increased robustness of more than 1 dB, a change of code rate may be effective when compared to shortening and/or bit repetitions.

Having a larger base codeword is helpful for this scheme. The codeword may be extended, e.g., by extending the parity section of the FEC codeword. To change the level of overhead in a wider range, puncturing and shortening may be combined and different FEC code rates may be selected.

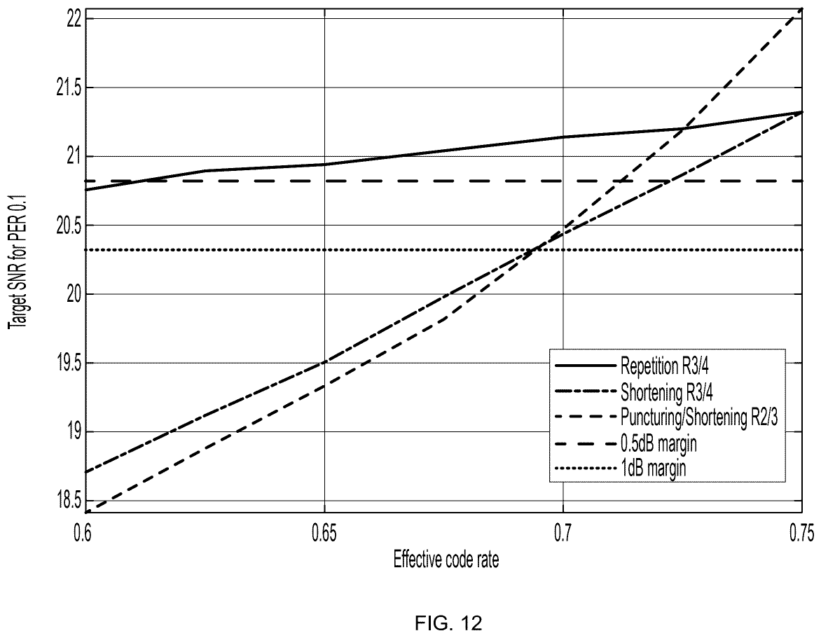

FIG. 12 shows a comparison between different methods to increase robustness for the example of MCS 8 (256-QAM, code rate ¾) and effective code rates between 0.6 and 0.75. The target SNR for PER of 0.1 is graphed as a function of the effective code rate.

Bit repetitions may be used to vary the effective code rate over a wide range, but provide little additional robustness, e.g., for 0.5 dB additional margin, the throughput is dropped almost 20%. When using shortening only, a throughput decrease of 4% is sufficient for 0.5 dB extra margin and less than 8% throughput decrease for 1 dB additional margin. To gain more than 1 dB margin, a combination of puncturing, shortening and a reduced FEC code rate was most effective.

### Example 3

### Rate Matching Strategy

For a rate matching strategy, some dependencies between packet size, code rate, and available bits are summarized.

The PHY parameters may be the number of carrier K, number of bits per carrier of the QAM constellation b and number of spatial streams L. The LDPC may be characterized by the number of payload bits K_{FEC} and the codeword size N_{FEC}. The overall payload of the WLAN frame may depend on the packet size N_{byte,packet}.

The input parameters may include: (1) the payload size in bits (uncoded): N_{pld}=N_{byte,packet}·8+16; (2) the number of bits per OFDM symbol: N_{cbps}=K b L, (3) the LDPC payload/codeword size: K_{FEC}, N_{FEC}, and the FEC code rate:

$$ρ = \frac{{K}_{FEC}}{{N}_{FEC}} .$$

The FEC and frame settings may include: (1) puncturing bits (sum for the codewords): N_{puncture}, (2) shortening bits (sum for the codewords): Nₛₕₒᵣₜₑₙ, (3) Repetition bits (sum for the codewords): Nᵣₑₚₑₜᵢₜᵢₒₙ, (4) number of OFDM symbols: N_{sym}, and (5) number of codewords: N_{cw}.

There are some rules that may be followed by a valid framing. The dependency between FEC bits and payload bits may be:

$${\sum }_{i = 1}^{{N}_{cw}} {K}_{FEC} - {N}_{shorten} = {N}_{pld}$$

The dependency between FEC bits and the number of bits of the OFDM symbols may be given by:

$${\sum }_{i = 1}^{{N}_{cw}} {N}_{FEC} - {N}_{shorten} - {N}_{puncture} + {N}_{repetition} = {N}_{sym} {N}_{cbps}$$

Some generic constraints may include: N_{puncture}≥0; Nₛₕₒᵣₜₑₙ≥0; Nᵣₑₚₑₜᵢₜᵢₒₙ≥0; N_{sym}≥1; and N_{cw}≥1.

Besides that, there may be some logical rules for useful framing settings. For example, repetition and puncturing may compensate each other: Thus, one of them is applied at a time, N_{puncture}·Nᵣₑₚₑₜᵢₜᵢₒₙ=0. In addition or alternatively, the minimum number of codewords with K_{FEC} payload bits may be

$${N}_{cw} \geq ⌈ \frac{{N}_{pld}}{{K}_{FEC}} ⌉ .$$

In addition or alternatively, the minimum number of OFDM symbols (code rate ρ=1) may be

$${N}_{sym} \geq ⌈ \frac{{N}_{pld}}{{K}_{cbps}} ⌉ .$$

In addition or alternatively, the maximum number of OFDM symbols with a code rate ρₘᵢₙ may be

$${N}_{sym} \geq ⌈ \frac{{N}_{pld}}{{ρ}_{min} {N}_{cbps}} ⌉ .$$

For fixed codeword settings, various rules may be used to select the FEC settings. For example, the FEC codeword size K_{FEC}, N_{FEC} may be as large as possible, because larger codewords may have a higher coding gain, but with limited puncturing/shortening, which may degrade performance.

With a set of available codeword sizes, e.g., N_{FEC}∈{648, 1295, 1944, 3888} bits, the codeword size may be selected, based on the minimum number of symbols used for the payload and the available bits of the OFDM symbols:

$${N}_{sym , min} = ⌈ \frac{{N}_{pld}}{{ρ}_{min} {N}_{cbps}} ⌉ .$$

This gives N_{avbits,min}=N_{sym,min}N_{cbps}.

A rule, which may keep the number of codewords to the minimum, may be:

$$\begin{matrix}{N}_{avbits , min} \leq 648 : {N}_{FEC} = 648 ( {N}_{cw} = 1 ) ; \\ 648 < {N}_{avbits , min} \leq 1296 : {N}_{FEC} = 1296 ( {N}_{cw} = 1 ) , max . pct . / short . 50 \% ; \\ 1296 < {N}_{avbits , min} \leq 1944 : {N}_{FEC} = 1944 ( {N}_{cw} = 1 ) , max . pct . / short . 33.3 \% ; \\ {N}_{avbits , min} > 1944 : {N}_{FEC} = 3888 ( {N}_{cw} = 1 ) , max . pct . / short . 50 \% .\end{matrix}$$

However, this rule may cause excessive shortening and puncturing up to 50%, even for larger codewords. Limiting the puncturing and/or shortening to a lower percentage, e.g., 33.3% for larger codewords provides:

$${N}_{avbits , min} \leq 648 : {N}_{FEC} = 648 ( {N}_{cw} = 1 )$$

$$648 < {N}_{avbits , min} \leq 1296 : {N}_{FEC} = 1296 ( {N}_{cw} = 1 ) , max . pct . / short . 50 \%$$

$$1296 < {N}_{avbits , min} \leq 1944 : {N}_{FEC} = 1944 ( {N}_{cw} = 1 ) , max . pct . / short . 33.3 \%$$

$$1944 < {N}_{avbits , min} \leq 2592 : {N}_{EEC} = 1296 ( {N}_{cw} = 2 ) , max . pct . / short . 25 \%$$

$$2592 < {N}_{avbits , min} \leq 3888 : {N}_{FEC} = 3888 ( {N}_{cw} = 1 ) , max . pct . / short . 33.3 \%$$

$$3888 < {N}_{avbits , min} \leq 5832 : {N}_{FEC} = 1944 ( {N}_{cw} = 3 ) , max . pct . / short . 33.3 \%$$

$$7776 < {N}_{avbits , min} \leq 11664 : {N}_{FEC} = 3888 ( {N}_{cw} = 3 ) , max . pct . / short . 33.3 \% .$$

For large frames with many OFDM symbols and multiple packets, the maximum N_{FEC} may be used. While N_{sym}=N_{sym,min} provides the highest code rate, additional symbols may be introduced to achieve additional overhead to protect the sensitive part of the frame. This may be done when the effective code rate

$${ρ}_{eff} = \frac{{N}_{pld}}{{N}_{sym} {N}_{cbps}}$$

is higher than selected.

Different values for N_{cw}, satisfying

$${N}_{cw} \geq ⌈ \frac{{N}_{pld}}{{K}_{FEC}} ⌉$$

may be considered, which may lead to different values for puncturing/shortening. For a given N_{cw}, the number of shortening bits may be

$${\sum }_{i = 1}^{{N}_{c w}} {K}_{FEC} - {N}_{pld} = {N}_{s horten} .$$

Consequently, there may be shortening bits may be

$${N}_{puncture} = {\sum }_{i = 1}^{{N}_{c w}} {N}_{FEC} - {N}_{s horten} - {N}_{sym} {N}_{cbps} ; {N}_{repetition} = 0$$

in case that

$${\sum }_{i = 1}^{{N}_{c w}} {N}_{FEC} - {N}_{s horten} > {N}_{sym} {N}_{cbps} ;$$

or there may be

$${N}_{repetition} = {N}_{sym} {N}_{cbps} + {N}_{s horten} - {\sum }_{i = 1}^{{N}_{c w}} {N}_{FEC}$$

in case that

$${\sum }_{i = 1}^{{N}_{c w}} {N}_{FEC} - {N}_{s horten} < {N}_{sym} {N}_{cbps} .$$

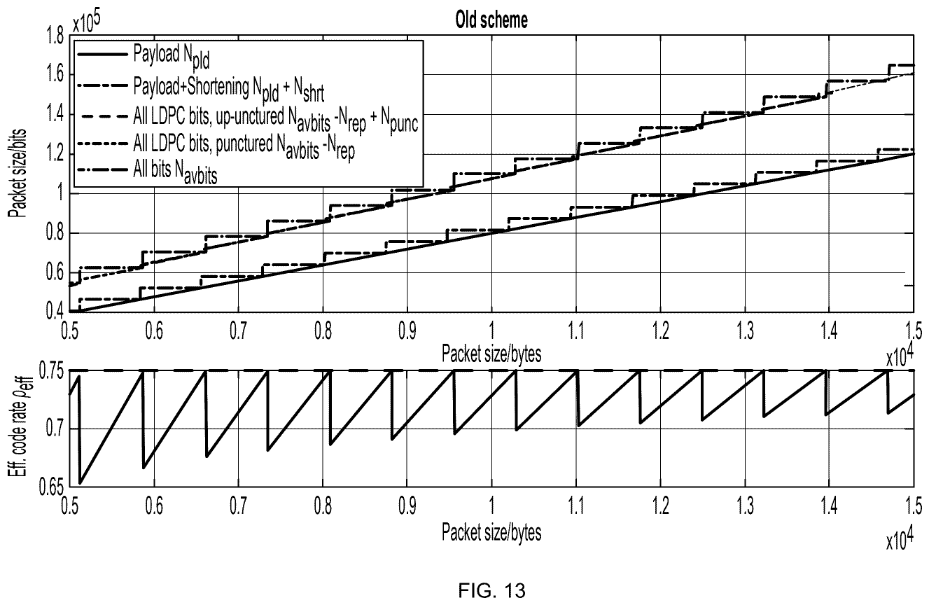

As illustrated in FIG. 13, a legacy Wi-Fi® alignment strategy for payload up to 10,000 bytes is shown, assuming 1 spatial stream, 80 MHz, 8 bit QAM transmission, and a target code rate of ¾. The packet size per bits and the effective code rate is graphed as a function of the packet size per bytes.

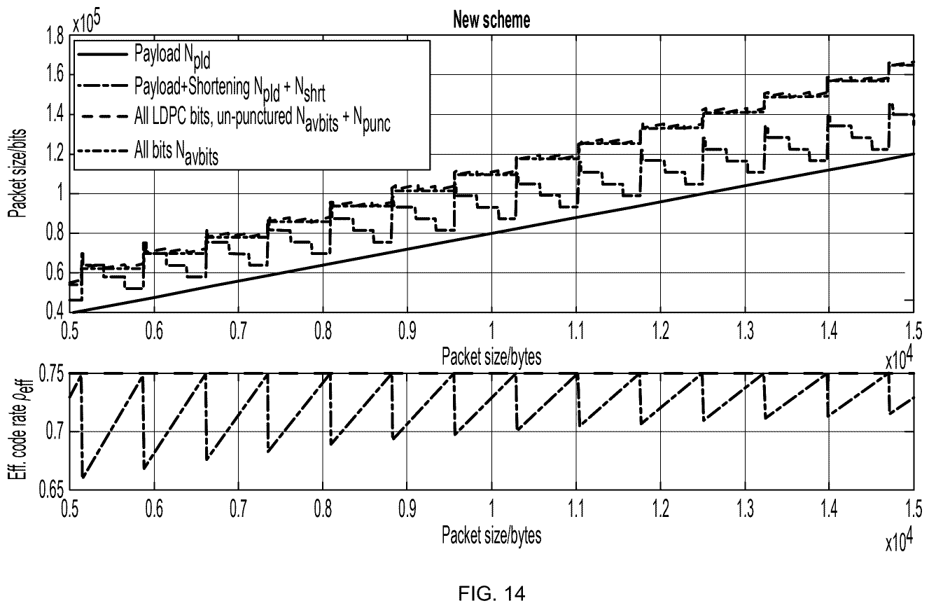

With a proper choice of N_{cw}, the alignment may do more repetitions or more puncturing. For example, FIG. 14 shows a strategy where repetitions are not used. In FIG. 14, alignment strategy is shown without repetitions, up to 10,000 bytes, assuming 1 spatial stream, 80 MHz, 8-bit QAM transmission, and a target code rate of ¾. The packet size per bits and the effective coding rate are graphed as a function of the packet size per bytes. There is a linear relationship between the packet size in bytes and the packet size in bits for a payload of N_{pld}.

When shortening is used (i.e., N_{pld}+Nₛₕᵣₜ), the relationship between the packet size in bytes and the packet size in bits is no longer linear. The effective coding rate when shortening is used (i.e., N_{pld}+Nₛₕᵣₜ) varies between 0.65 and 0.75 for the different packet sizes per bytes. As the packet size per bytes increases, the effective coding rates has less variability and a higher effective coding rate.

When puncturing is used (i.e., N_{avbits}+N_{punc}), the relationship between packet size per bytes and packet size per bits varies as shown. When all bits are used (i.e., N_{avbits}), the relationship between packet size per bytes and packet size per bits varies as shown.

In the example of FIG. 14, the effective code rate may still be equal to

$$ρ = \frac{{K}_{FEC}}{{N}_{FEC}}$$

for certain payload sizes, which may not allow for additional protection on certain symbols. Selecting ρₘₐₓ>ρ may provide for a certain amount of overhead. To ensure ρₘₐₓ limit, the following rule may be used: while

$${ρ}_{eff} = \frac{{N}_{pld}}{{N}_{sym} {N}_{cbps}} > {ρ}_{max} : increase {N}_{sym} .$$

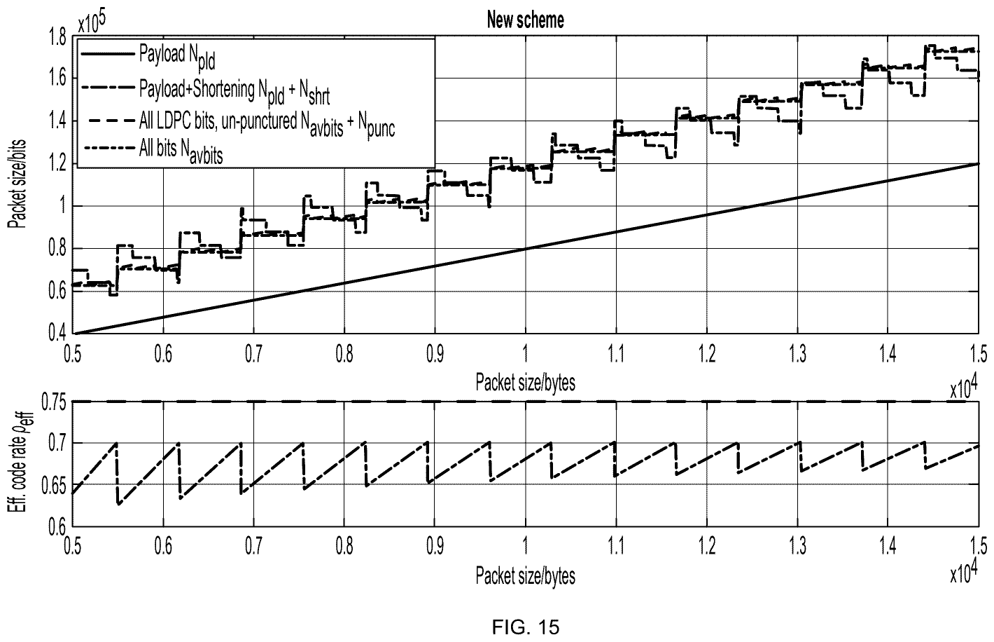

An example is shown in FIG. 15. This rule lowers the variation of the effective code rate when shortening is used (i.e., N_{pld}+Nₛₕᵣₜ). In this example, the effective code rate is equal to

$$0.7 < \frac{{K}_{FEC}}{{N}_{FEC}} = 0.75 .$$

To achieve a limit of the maximum effective code rate, which may be lower than what is given by the LDPC settings, an additional OFDM symbol may be introduced whenever the selected maximum code rate ρₘₐₓ is exceeded. The figures show payload sizes up to 10 kBytes. With larger payloads, the variation of the effective code rate lowers and the target code rate may be reached more and more efficiently.

### Example 4

### Overhead Assignment

The overhead may be distributed differently between the symbols and may be controlled by two parameters, the number of FEC codewords using additional protection N_{cw,protect} and the ρ_{max,protect}.

From the rate matching strategy, the aggregated number of puncturing bits N_{puncture}, the number of repetition bits Nᵣₑₚₑₜᵢₜᵢₒₙ and the number of shortening bits Nₛₕₒᵣₜₑₙ may be known, as well as the overall number of codewords N_{cw}.

For the codewords with higher protection, N_{cw,protect} and ρ_{max,protect} are defined in addition. The average effective code rate is

$${ρ}_{avg} = \frac{{N}_{cw} {K}_{FEC} - {N}_{shorten}}{{N}_{cw} {N}_{FEC} - {N}_{shorten} - {N}_{puncture} + {N}_{repetition}} .$$

For each codeword, the number of shortening, puncturing, and repetition bits may be an integer, e.g.,

$${ρ}_{max , protect} = \frac{{K}_{FEC} - {N}_{shorten , protect}}{{N}_{FEC} - {N}_{shorten , protect} - {N}_{puncture , protect} + {N}_{repetition , protect}} .$$

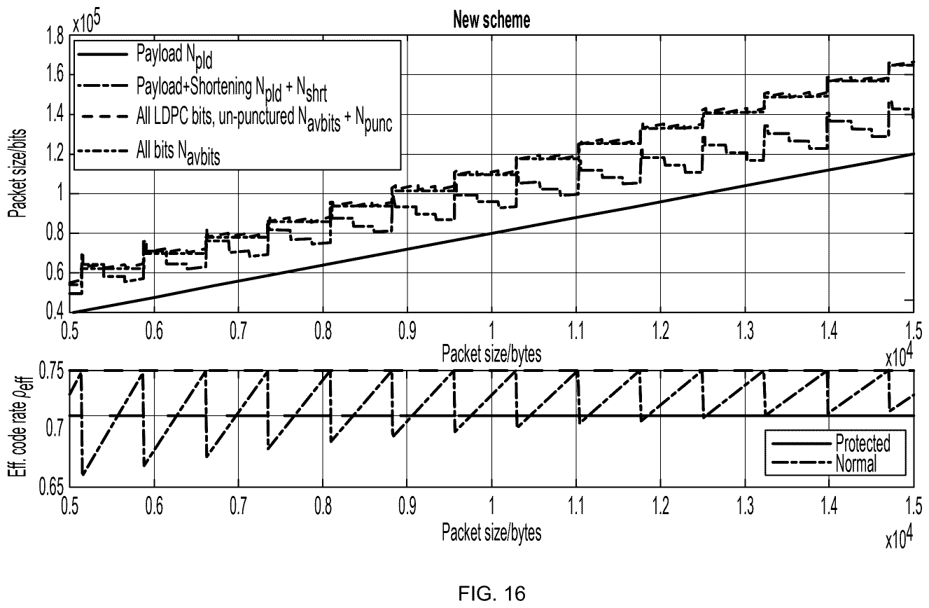

An example is shown in FIG. 16. In the example, there may be a fixed max effective code rate for the protected part of the frame. The number of protected codewords may be derived from the size of the payload to be protected or from the convergence time of the receiver. In the example, the number of puncturing bits may be reduced for the protected codewords in a first operation. If this is not sufficient to achieve the selected code rate, the number of shortening bits may be increased until the selected code rate is achieved. If this is not sufficient, the procedure may be repeated with an additional OFDM symbol (an extra OFDM symbol was not used in FIG. 16).

As shown in the lower plot of FIG. 16, the code rate of the protected codewords may not exceed the target of ρ_{max,protect}=0.7. With increasing payload size, the protected codewords may meet the target code rate of 0.7, while the non-protected codewords may converge to the default code rate of 0.75.

In another example, a relative difference between the protected codeword overhead and the un-protected codeword overhead may be used. Additional overhead may be specified in terms of the percentage of overhead, or in terms of additional SNR margin.

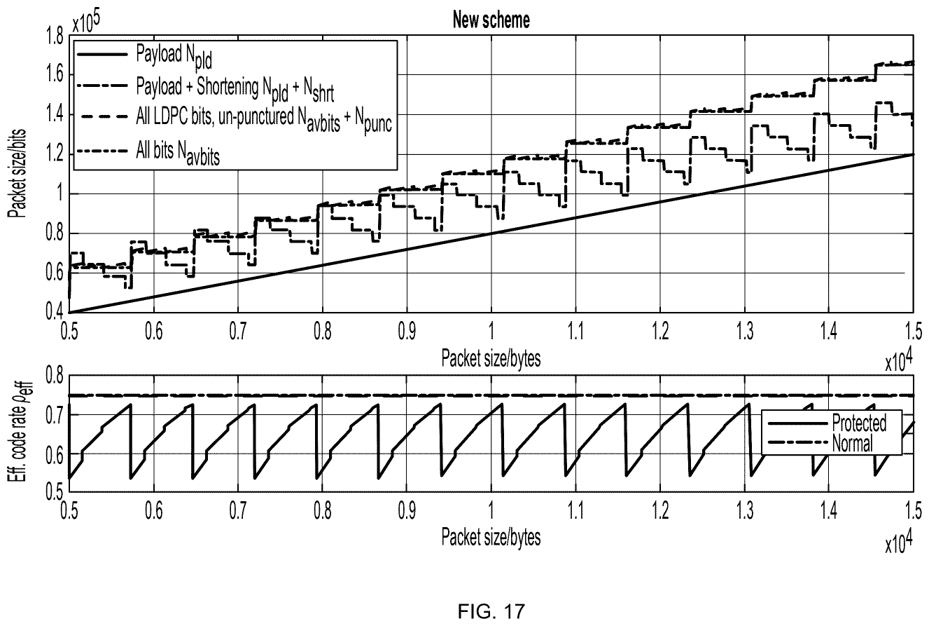

In another example, as shown in FIG. 17, the code rate of the un-protected part of the frame may be fixed, while the overhead created by frame alignment may be used for the protected codewords. A mix of the schemes may be used.

### Example 5

Simulation Results-Latency Enhancement with Unequal Protection

Latency enhancement may be achieved by using unequal protection. Numerous assumptions may be used including retransmitted packets at the PPDU start, fixed protection of 10 initial symbols with a 1 dB extra margin, an average packet error rate of 0.1, an MCS of 4, and 1 spatial stream.

The transmission latency may depend on the network load, e.g., the data traffic, relative to the available PHY rate (wait time for the medium to be free), the number of active STAs (collisions) and the packet error rate (retransmissions).

The packet error rate may impact latency in two ways. Due to lost packets, the effective throughput may be decreased, and retransmissions may cause increased latency for the re-transmitted packet.

To model receiver convergence, the PER convergence results from PHY simulations from FIGS. 10 and 11 were used.

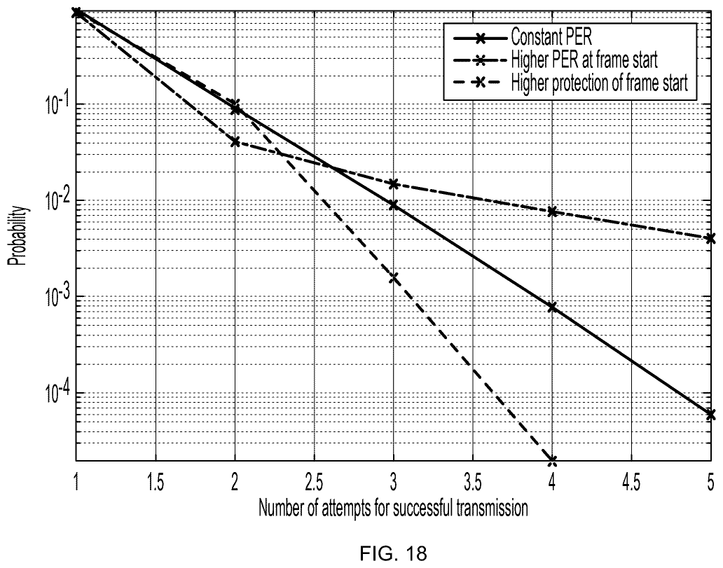

System level simulation was performed with downlink transmission to 2 STAs. Error! Reference source not found. shows the counts for the number of transmission attempts of a successfully received packet for different cases. For the cases shown in FIG. 18, the average PER throughout the frame was constant.

The first case, constant packet error rate in the frame, was the default case. The probability of multiple attempts to transmit a packet dropped exponentially.

With some receivers, there may be a higher PER at the frame start due to receiver convergence effects, as shown in FIGS. 10 and 11. This may cause the probability of a packet retransmitted multiple times significantly, as shown with the second case in Error! Reference source not found.

With the present disclosure, the retransmitted packets may be protected with additional overhead. This was the third case shown in Error! Reference source not found. (higher protection of frame start). With that, the probability of multiple retransmissions and thus, the worst case latency, was reduced, and was lower than that achieved with a constant PER.

Error! Reference source not found. shows the statistics of packet latency in milliseconds, which shows the actual latency in more detail. In all cases, most packets may be received correctly at the first attempt, causing latencies up to 6 ms.

Due to receiver convergence, the probability of a successful reception after one retransmission may be lower than with a constant PER, because many of those packets fail again. With the additional protection of the retransmitted frames, a second retransmission happens in rare cases (e.g., a collision), which bounds the latency to a maximum around 12 ms.

Error! Reference source not found. show how the latency behaves with respect to data traffic. With traffic at more than 80% of the PHY rate, the latency raises due to congestion. But up to that, the latency enhancement using additional protection of the frame start to compensate the convergence effects of the receiver is visible. With additional protection of the retransmitted packets, the 99% worst case latency may be reduced further.

### Example 6

### Framing Changes for More Shortening

Increasing N_{CW} to beyond the minimum

$$( i . e . , {N}_{CW} > ⌈ \frac{{N}_{pld}}{3888 R} ⌉ )$$

may give more shortening and less repetition bits without further changes in the framing rules.

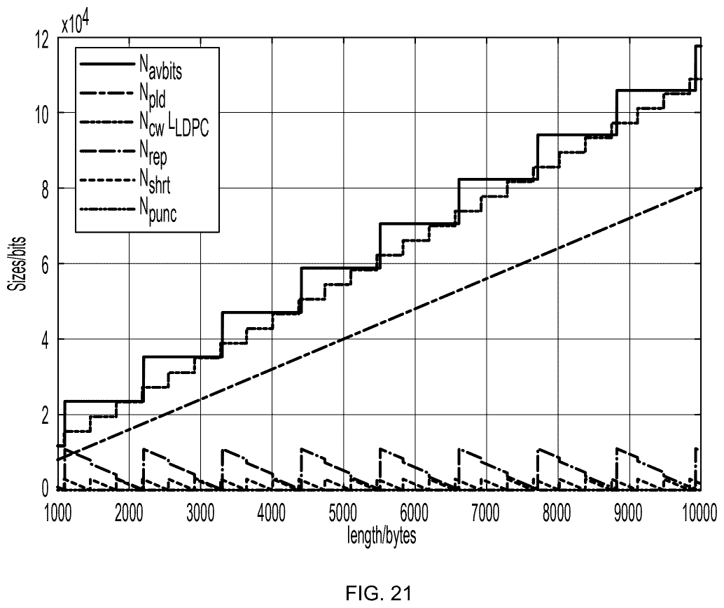

As illustrated in FIG. 21, for N_{CW}=[N_{pld}/3888R], the repetition bits vary between 0 and 1×10⁴ in size per bits. For

$$⌈ \frac{{N}_{pld}}{3888 R} ⌉ \leq {N}_{CW} \leq ⌈ \frac{{N}_{pld}}{3888 R} ⌉ + 4 ,$$

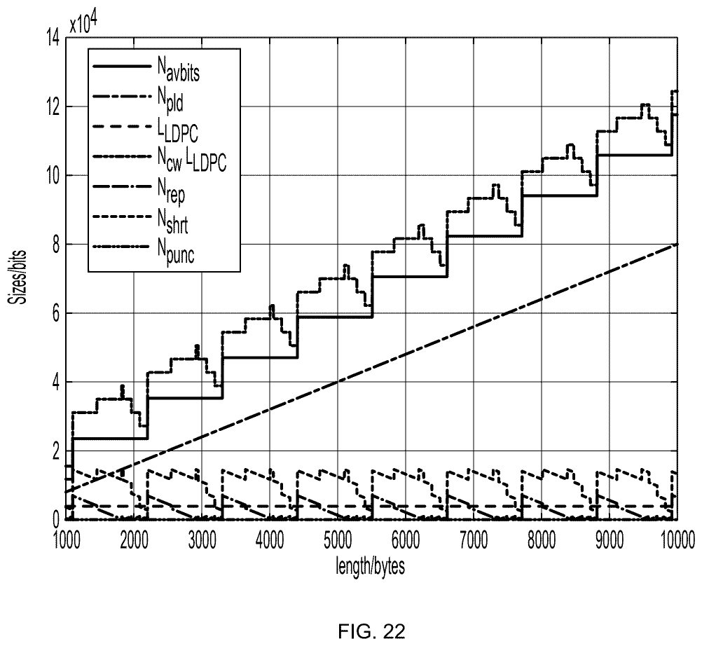

there may be more shortening bits and fewer repetition bits, as illustrated in FIG. 22. The repetition bits may vary between 0 and 0.5×10⁴ in size per bits and the shortening bits may vary between 0 and 1.5×10⁴ in size per bits.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. An access point (AP), comprising:
a processing device operable to:
identify, at the AP, a first portion of a wireless local area network (WLAN) frame and a second portion of a WLAN frame, wherein the first portion of the WLAN frame comprises a first set of one or more codewords having a first protection level and the second portion of the WLAN frame comprises a second set of one or more codewords having a second protection level;
select, at the AP, a first forward error correction (FEC) setting for the first portion of the WLAN frame to facilitate the first protection level; and
select, at the AP, a second FEC setting for the second portion of the WLAN frame to facilitate the second protection level.

2. The access point of claim 1, wherein the first FEC setting comprises one or more of an increased number of shortening bits or a reduced number of puncturing bits when compared to the second FEC setting.

3. The access point of claim 1, wherein the first FEC setting has a lower FEC code rate when compared to the second FEC setting.

4. The access point of claim 1, wherein the first portion of the WLAN frame comprises one or more retransmitted data units.

5. The access point of claim 1, wherein the first portion of the WLAN frame comprises one or more additional orthogonal frequency division multiplexing (OFDM) symbols when compared to a minimum number of OFDM symbols.

6. The access point of claim 1, wherein the processing device is operable to align one or more of the FEC settings, orthogonal frequency division multiplexing (OFDM) settings, or payload size without using repetitions.

7. The access point of claim 1, wherein the processing device is operable to receive, at the AP from a station (STA), a request for protection of the first portion of the WLAN frame.

8. The access point of claim 1, wherein the processing device is operable to identify, at the AP, receiver convergence based on an increased error rate in the first portion of the WLAN frame.

9. The access point of claim 1, wherein the processing device is operable to communicate, from the AP to a station (STA), one or more of a number of orthogonal frequency division multiplexing (OFDM) symbols having the first protection level, a position of OFDM symbols having the first protection level, a number of the first set of the one or more codewords having the first protection level, a position of the first set of the one or more codewords having the first protection level, a code rate identifying an additional overhead for the first portion of the WLAN frame when compared to the second portion of the WLAN frame, or an indication for frame alignment.

10. A station (STA), comprising:
a processing device operable to:
identify, at the STA, a first portion of a wireless local area network (WLAN) frame and a second portion of a WLAN frame, wherein the first portion of the WLAN frame comprises a first set of one or more codewords having a first protection level and the second portion of the WLAN frame comprises a second set of one or more codewords having a second protection level;
select, at the STA, a first forward error correction (FEC) setting for the first portion of the WLAN frame to facilitate the first protection level; and
select, at the STA, a second FEC setting for the second portion of the WLAN frame to facilitate the second protection level.

11. The station of claim 10, wherein the first FEC setting comprises one or more of an increased number of shortening bits or a reduced number of puncturing bits when compared to the second FEC setting.

12. The station of claim 10, wherein the first FEC setting has a lower FEC code rate when compared to the second FEC setting.

13. The station of claim 10, wherein the first portion of the WLAN frame comprises one or more retransmitted data units.

14. The station of claim 10, wherein the first portion of the WLAN frame comprises one or more additional orthogonal frequency division multiplexing (OFDM) symbols when compared to a minimum number of OFDM symbols.

15. The station of claim 10, wherein the processing device is operable to align one or more of the FEC settings, orthogonal frequency division multiplexing (OFDM) settings, or payload size without using repetitions.

16. The station of claim 10, wherein the processing device is operable to receive, at the STA from an access point (AP), a request for protection of the first portion of the WLAN frame.

17. The station of claim 10, wherein the processing device is operable to identify, at the STA, receiver convergence based on an increased error rate in the first portion of the WLAN frame.

18. The station of claim 10, wherein the processing device is operable to communicate, from the STA to an access point (AP), one or more of a number of orthogonal frequency division multiplexing (OFDM) symbols having the first protection level, a position of OFDM symbols having the first protection level, a number of the first set of the one or more codewords having the first protection level, a position of the first set of the one or more codewords having the first protection level, a code rate identifying an additional overhead for the first portion of the WLAN frame when compared to the second portion of the WLAN frame, or an indication for frame alignment.

19. A computer-readable storage medium including computer executable instructions that, when executed by a processing device, cause an access point (AP) to:
identify, at the AP, a first portion of a wireless local area network (WLAN) frame and a second portion of a WLAN frame, wherein the first portion of the WLAN frame comprises a first set of one or more codewords having a first protection level and the second portion of the WLAN frame comprises a second set of one or more codewords having a second protection level;
select, at the AP, a first forward error correction (FEC) setting for the first portion of the WLAN frame to facilitate the first protection level;
select, at the AP, a second FEC setting for the second portion of the WLAN frame to facilitate the second protection level; and
transmit, from the AP to a station (STA), the WLAN frame.

20. The computer-readable storage medium of claim 19, wherein the first FEC setting comprises one or more of an increased number of shortening bits or a reduced number of puncturing bits when compared to the second FEC setting.
